(19) United States
(12) Patent Application Publication
(10) Pub. No.: US 2009/0072486 A1
(43) Pub. Date: Mar. 19, 2009

(54) Brush seal

(75) Inventor: Amitava Datta, East Greenwich, RI (US)

Correspondence Address: BAINWOOD HUANG & ASSOCIATES LLC, 2 CONNECTOR ROAD, WESTBOROUGH, MA, 01581, US

(73) Assignee: Rexnord Industries, LLC, Milwaukee, WI (US)

(21) Appl. No.: 11/787,301

(22) Filed: Apr. 14, 2007

Related U.S. Application Data
(63) Continuation-in-part of application No. 11/121,872, filed on May 4, 2005.
(60) Provisional application No. 60/567,905, filed on May 4, 2004.

(51) Int. Cl. F16J 15/44

(52) U.S. Cl. 277/355

(57) ABSTRACT

A brush seal for sealing gaps, such as those found in gas turbine engines, includes a plurality of metallic bristles mechanically captured by a support member. The support member includes at least one flexible plate extending at least substantially along the bristle length of the plurality of bristles. The support member is constructed and arranged to support the plurality of metallic bristles during operation.

### CROSS REFERENCES TO RELATED APPLICATIONS

The present application is a continuation-in-part of U.S. Utility application Ser. No. 11/121,872, filed May 4, 2005, entitled “Non-metallic Brush Seals,” which claims the benefit of U.S. Provisional Application No. 60/567,905 filed May 4, 2004. The entire content of the above applications is incorporated by reference herein.

### TECHNICAL FIELD

Embodiments of the invention relate to brush seals for sealing a gap between a high pressure and a low pressure area.

### BACKGROUND

The use of brush seals for sealing gaps, such as those found in gas turbine engines, is known in the art. For example, in gas turbine engines brush seals are often utilized to minimize leakage of fluids at circumferential gaps, such as between a machine housing and a rotor, around a rotary shaft of the engine, and between two spaces having different fluid pressure within the engine. The fluid pressure within the system, which may be either liquid or gas, is greater than the discharge pressure (the pressure outside the area of the engine housing, toward which the fluid will tend to leak), thus creating a pressure differential in the system. As used herein, the system pressure side of the brush seal is referred to as the high pressure side, while the discharge pressure side of the brush seal is referred to as the low pressure side.

Conventional brush seals include a bristle pack which is traditionally flexible and includes a plurality of bristles for sealing the gap, the bristles having a free end for contacting one component, such as the rotor. Circular brush seals have been utilized in gas turbine engine applications to minimize leakage and increase engine fuel efficiency. Conventional brush seals are made from metallic fibers, which are typically cobalt or nickel-base high temperature superalloy wire products suitable for elevated temperature operation.

Because brush seals are contacting seals where bristle tips establish sealing contacts against the rotor surface, their applications are generally limited to surface speeds of less than about 1200 ft/sec and temperatures below about 1500° F. and usually below about 1200-1300° F. At extremely high surface speeds and temperatures, metallic brush seals have been found to suffer from excessive wear resulting from bristle tip melting. There are many areas in existing gas turbine engines, such as balance piston and other secondary flow areas near the gas path where surface speed and temperature conditions are typically beyond the capabilities of conventional metallic brush seals. As such, these locations are generally sealed by large-gap labyrinth seals which have been found to have high levels of leakage during use as compared to contacting seals such as carbon seals and metallic brush seals. Rotating intershaft seals, for both co-rotating and counter-rotating shafts, for example in advanced military aircraft engines, are also generally labyrinth type seals.

Metallic brush seals are also traditionally not used for sealing buffer air near the bearing cavity. Buffer air is used to seal the bearing lubricant by pressurizing the buffer air higher than that of bearing lubricating oil pressure. Metallic brush seals are not used because of metallic debris could reach the interface between the bearing elements (e.g., balls, pins, etc.) and races causing bearing and rotor damage and possibly failure. Again, current seals used at these locations are generally high-leakage labyrinth seals. Higher leakage for bearing oil seals is not desirable because of contamination of downstream components and cabin air that can be introduced through the leak path. Appropriate carbon seals have not yet been developed for such applications because of their fragile characteristics and low damage tolerance.

Large diameter main shaft bearing oil seals for large aircraft engines or land based turbo machinery are also typically labyrinth seals with large clearances that lead to oil contamination. In these applications large diameter carbon seals are expensive and metallic brush seals are not suitable.

Although there have been developments in creating non-metallic brush seals, the use of polymeric or ceramic material to replace the metallic bristles has met with many design challenges due, in part, to the difficulty in handling and fabricating brush seals from such material. Typically ceramic or polymeric fibers are very thin, averaging in the range of about 2-3 μm in diameter. Fibers that are this thin have not traditionally been considered suitable for fabricating bristle strips. For example, the flexibility of the fibers can make it difficult to machine the inner diameter (ID) of the brush seal to the required tolerances.

Therefore, there exists a need for a contacting seal that minimizes leakage as compared to traditional labyrinth type seals and which can operate under higher temperatures and/or higher speeds than existing metallic brush seals and which can be readily fabricated.

### SUMMARY

In accordance with one embodiment of the present invention, there is provided a contacting brush seal including a plurality of fibers fabricated from non-metallic materials, the fibers being twisted or braided together substantially along their length (L). The fibers may be particularly made from ceramic or polymeric materials, and in one embodiment are more particularly fabricated from NOMEX®, a synthetic aromatic polyamide polymer, manufactured by DuPont for high temperature applications. The non-metallic ceramic brush seals disclosed herein have melting points much higher than those of nickel and cobalt base superalloys and, therefore, should prevent the tips from melting under most conditions. In addition, brush seals made from softer high strength polymeric fibers with moderate (about 500-700° F.) temperature capability, may also be used for high performance bearings such as counter-rotating bearing cavities of advanced gas turbine engines.

In accordance with one embodiment, a brush seal includes a plurality of metallic bristles and a support member that mechanically captures the plurality of metallic bristles. In one arrangement, the support member includes a pair of relatively rigid front and back plates and a pair of relatively flexible front and back plates, the plurality of metallic bristles, such as formed as a flexible bristle pack, being disposed between the front and back plates. The support member provides a level of rigidity to the flexible fiber pack. In one arrangement, the support member is configured to hold the flexible fiber pack in an axially inclined position such that the flexible fiber pack is coned either toward a low pressure area or a high pressure area in a brush seal system.

In one arrangement, a brush seal includes a plurality of metallic bristles having a bristle length and a support member constructed and arranged to support the plurality of metallic bristles. The support member includes at least one flexible plate extending at least substantially along the bristle length of the plurality of bristles.

In one arrangement, a brush seal system includes a contact rotor and a rotatable shaft, the contact rotor and the rotatable shaft defining a space therebetween. The brush seal system also includes a brush seal disposed between the contact rotor and the rotatable shaft to divide the pathway into a high pressure side and a low pressure side. The brush seal includes a plurality of metallic bristles having a bristle length and a support member constructed and arranged to support the plurality of metallic bristles. The support member has at least one flexible plate extending at least substantially along the bristle length of the plurality of bristles.

In one arrangement, a brush seal includes a plurality of brush seal members having a brush seal member length and a support member constructed and arranged to support the plurality of brush seal members. The support member includes at least one flexible plate extending at least substantially along the brush seal member length of the plurality of brush seal members. The plurality of brush seal members is configured as a brush seal pack. The support member is constructed and arranged to mount to a base and to orient the brush seal pack in an axially inclined position relative to the base.

### BRIEF DESCRIPTION OF THE DRAWINGS

It should be understood that the drawings are provided for the purpose of illustration only and are not intended to define the limits of the invention. The present invention is not limited to the precise arrangements and instrumentalities shown in the drawings and the drawings are not necessarily to scale, emphasis instead being placed upon illustrating the principles disclosed herein.

FIG. 1 is a perspective view of a mechanically captured brush seal.

FIG. 2 is schematic illustration of a brush seal design including a flexible front and back plate.

FIG. 3 is a schematic illustration of the flexible front and back plates of FIG. 2 including radial slots.

FIG. 4 is a photograph of twisted NOMEX® brand fibers such as used for the brush seal of FIG. 2.

FIG. 5 illustrates a configuration of a support member of FIG. 2 having a single flexible plate.

FIG. 6 illustrates a configuration of a support member of FIG. 2 positioning a fiber pack toward a high pressure area.

FIG. 7 illustrates a configuration of a support member of FIG. 6 having a single flexible plate.

### DETAILED DESCRIPTION

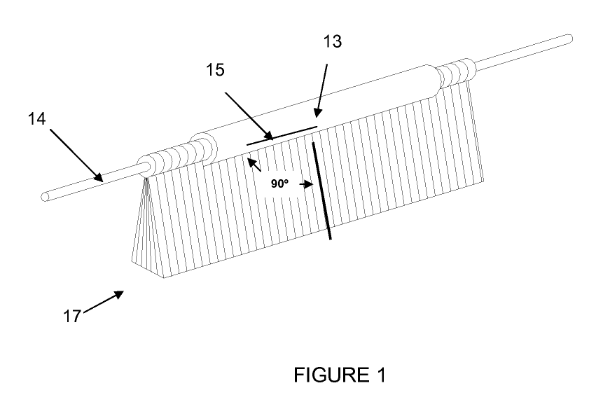

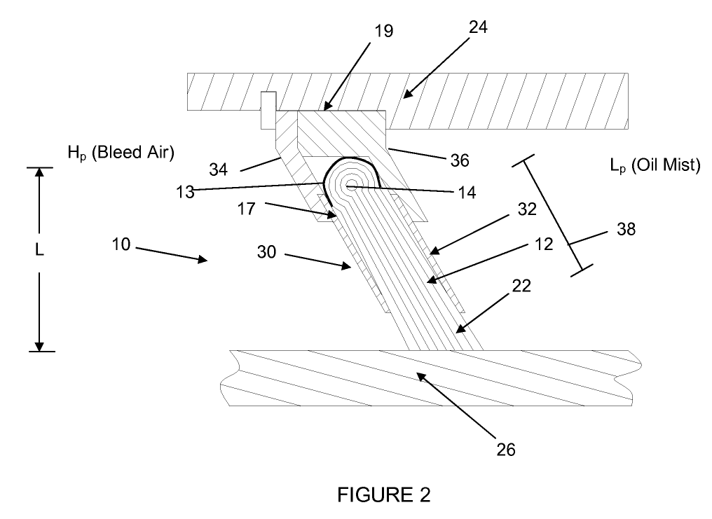

Referring initially to FIG. 2, there is illustrated a brush seal 10 including a brush strip or pack 17 having a plurality of brush seal members 12 supported around a rod or core 14. The plurality of brush seal members 12 can be formed of a ceramic or polymeric material (e.g., non-metallic fibers) to form a fiber pack. The plurality of brush seal members 12 can also be formed of a metallic material (e.g., metallic bristles) to form a bristle pack. In one arrangement, the brush seal members 12 are mechanically captured and secured as part of the brush strip 17. The brush seal members 12 may be folded or wound about the core 14 as shown schematically in FIG. 1. In the present embodiment, a clamping channel 13, such as the conventional channel or U-ring, may be utilized to further secure the brush seal members 12 to the core wire 14 by crimping the channel 13 over the wound brush seal members 12. For added security, the brush seal members 12 may be glued or cemented to the rod 14 in the mechanically captured condition, as desired. Additionally, in the case where the brush seal members 12 are formed as metallic bristles, the metallic bristles can be welded to the core 14 to form the brush seal.

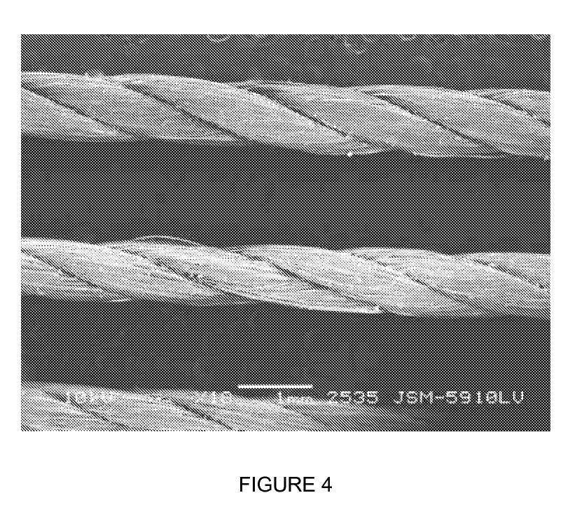

In the case where the brush seal members 12 are formed as ceramic or polymeric fibers, the ceramic or polymeric fibers are preferably twisted or braided, as illustrated in FIG. 4, into thicker diameter filaments about 0.02″-0.05″ in diameter. Brush seals 10 can be fabricated from these braided filaments as described below. Ceramic fibers may be made from suitable high temperature ceramic filaments, including, but not limited to: Aluminum Oxide/Silicon Oxide/Boron Oxide or Nextel™ fiber (3M, St. Paul, Minn.); Silicon carbide fiber; other ceramic fibers generally made for ceramic/metal or ceramic/ceramic composites. Polymeric fibers may be made from suitable high temperature polymeric materials, including, but not limited to: KEVLAR® brand filaments for extremely high strength; and NOMEX® filaments for high strength and moderate temperature (˜300° C.) applications. Both KEVLAR® and NOMEX® are synthetic aromatic polyamide polymer manufactured by DuPont. Other suitable polymeric materials may be utilized for the twisted or braided filaments for brush seals 10, as would be known to those of skill in the art.

In one embodiment, NOMEX®, can be selected for brush seal fabrication because the NOMEX® fibers are generally made into strong fabrics for applications where thermal and flame resistant properties are essential. NOMEX® is the high temperature version of KEVLAR® which is as strong as or stronger than high strength steel. Other general properties of NOMEX® include: 1.) usable in wide range of temperatures from −196° C. to over 300° C.; 2.) broad compatibility with industrially used oils, resins, adhesives and refrigerants; 3.) chemical resistance to acids, alkalis and solvents; 4.) non-toxic; 5.) self-extinguishing; 6.) does not support combustion; and 7.) does not drip or melt when heated or burned.

In one embodiment, Nextel™ can be selected for brush seal fabrication. Nextel™ fibers are very thin, in the range of about 25 μm to 0.001″ in diameter, and have a low modulus of elasticity. In this embodiment, the fibers are twisted as shown in FIG. 4 to fabricate the brush strips. The twisted Nextel™ fibers are much thicker than the individual fibers, the twisted fibers having a thickness in the range of about 900 μm to 0.036″ in diameter and they are rigid enough to make brush strips using the conventional automatic brush strip manufacturing process. This helps to reduce the fabrication cost of Nextel™ brush strips which will be formed or rolled into brush seal inserts as explained below. Current automated mechanically captured brush strip manufacturing processes are suitable for producing brush strips where brush seal members 12 are inclined at about 90° to the strip axis 15 and are disposed normal to a rotor surface as indicated in FIG. 1. Typically, for metallic brush seals, bristles are inclined at about 0° to 45° to the strip length in the direction of rotation to provide flexibility and aid in bristle bending during rotor excursion. When bristles are normal to the strip length or to a rotor surface, they tend to buckle rather than bend, thereby increasing the mechanical contact pressure (P_{mc}) at bristle tips. Increased P_{mc} accelerates bristle wear and shortens the seal life. In one embodiment, as shown in FIG. 2, in order to facilitate bending of the brush seal members 12 during rotor excursions, the brush member pack 17 is inclined axially, such as in the direction of the fluid flow (e.g., toward a low pressure (L_{P}) side within an engine). For example, the brush seal 10 can be attached to a stator housing or to a rotating shaft 24 at a first end and can contact a rotor 26 at a second to form an intershaft seal configuration. The flexible brush member pack 17 is held in an axially inclined position by a support member 19 having a pair of thinner front and back plates 30, 32 which are attached to more rigid front and back plates 34, 36 as shown in FIG. 2. The support member 19 is configured to provide some rigidity to the brush seal members 12 of the brush member pack 17.

The thinner and more flexible front and back plates, 30, 32 located near an inner diameter (ID) of the brush seal 10, protect the brush seal members 12 from damage during installation, aid in holding the brush member pack 17 together, and minimize its flaring. The flexible plates 30, 32 help to control axial and radial displacements of the brush seal members 12 by supporting the brush member pack 17 against pressure and centrifugal forces within a brush seal system (e.g., engine). The front plate 30 may be fabricated from a thin metallic strip which is configured to contact the brush member pack 17 when the brush seal system builds up pressure. Thus, the front plate 30 acts as a flow deflector minimizing brush seal members blow-down on a rotating surface, such as the rotor 26, causing excessive brush member wear. The flexible back plate 32 may also be made from a metallic sheet stock. However, the thickness of the flexible back plate 32 may be greater than the front plate thickness 30. The relatively thicker back plate 32 is designed to support the brush member pack 17 under pressure.

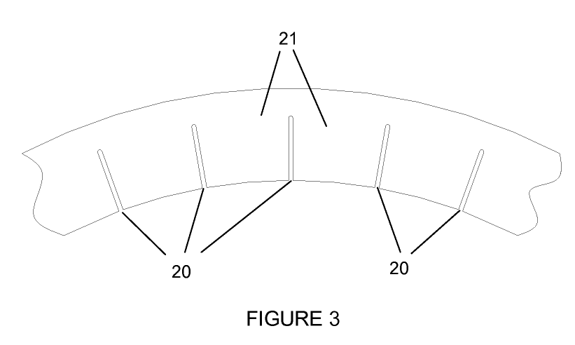

The flexible front and back plates 30, 32 may also be divided into segments 21 by radial slots 20 as shown in FIG. 3, thereby allowing the segments 21 to bend. By optimizing the design of the radial segments 21 of the flexible front and back plates 30, 32, the displacement of the brush member pack 17 caused by differential pressure and centrifugal forces at various operating conditions in a brush seal system can be controlled. For example, the brush member pack 17 is allowed to bend axially as the differential pressure and centrifugal force within the brush seal system increase with the rotor speed. By controlling axial bending of the brush member pack 17, the radial clearance between the ID of the brush seal 10 and an outer diameter (OD) of the rotor 26 or its interference can be maintained relatively constant throughout the engine operating cycle (e.g., after engine excursion).

The flexible plates 30, 32 can extend a predetermined length 38 of the brush seal members 12 so as to expose only a brush seal members tip area 22, and protect the brush seal members 12 from being damaged during installation and/or mishandling. The brush seal 10 may be attached to the rotating shaft 24 at a first end can contact the rotor 26 at a second end with the rotating shaft 24 and the rotor 26 configured to rotate in relatively opposing directions. For a rotating seal, the stresses in the brush seal members 12 resulting from the centrifugal force are minimized as the brush member pack 17 is supported by flexible metallic back plate segment 21. The metallic segments 21 are designed to withstand the maximum bending stress due to centrifugal force. By securing the brush member pack 17 between axially inclined (e.g., coned) front and back plates 30, 32 in the direction of the fluid flow, the front plate 30 can control brush memberpack 17 displacement and can minimize stresses in the brush member pack 17.

An order of magnitude value of the maximum bending stress induced in a rotating flexible metallic segment is estimated in the following example. The following example is provided for purposes of illustration only and is not intended to limit the scope of the present invention.

Assuming that the flexible back plate 32 is made from age hardened Inco 718 (density=0.295 lbm/(in)³ and Y.S=130,000 psi); the size of each finger segment 21 is:

width=1.0″, length=0.25″ and thickness=0.05″,

mass of each finger=1.0×0.25×0.05×0.295 lbm=0.0037 lbm

and at the center of mass of each finger segment 21,

surface speed=500 ft/sec

radius=0.5 ft;

centrifugal force (F_{cf}) acting radially outward on each finger segment 21 is given by:

$$\frac{( 0.0037 ) \times {( 500 )}^{2}}{.5} lbf or {F}_{cf} = 1850 lbf .$$

If the cant angle of the finger segments 21 with respect to a vertical plane=10°, the bending force (Fₙ) acting normally through the center of mass of each finger 21 is:

Fₙ=F_{cf} Sin 10°=1850×0.174=322 lbs.

[Note: The F_{cf} will vary along the length of the finger segment 21 and it needs to be integrated for a more accurate estimate]

Therefore, the maximum bending stress (σₘₐₓ) generated at the surface of each finger segment 21 is:

$${σ}_{max} = \frac{3 \cdot {F}_{n} \cdot L}{w \cdot {t}^{2}}$$

where,
Fₙ=normal force acting through the center of mass=322 lbf
L=length of finger=0.25″
w=width of fingers=1″
t=thickness of finger=0.05″

$${σ}_{max} = \frac{3 \times 322 \times .25}{1 \times {( .05 )}^{2}} = \text{96,000} psi$$

This stress is well below the yield stress of Inco 718. The rest of the rigid structure of the rotating seal can easily be optimized to maintain stresses below the yield stress. For design optimization, detailed Finite Element Analysis (FEA) of the entire structure may be performed.

It will be appreciated that the braided ceramic brush seals, as disclosed herein, can operate effectively at relatively high temperatures (above about 1500° F.) and at high surface speeds (exceeding about 1000 ft/sec) while being capable of being manufactured using standard automatic and low-cost brush strip manufacturing process. Controlled bending of the flexible plates 30, 32 and the brush member pack 17 also aid in controlling seal radial clearance or interference throughout the operating cycle of the bush seal system.

It will be understood that various modifications may be made to the embodiments disclosed herein. Therefore, the above description should not be construed as limiting, but merely as exemplifications of preferred embodiments. Those skilled in the art will envision other modifications within the scope, spirit and intent of the invention.

For example, although the fibers are illustrated as twisted in FIG. 4, the term “twisted” as used herein is intended to include braided configurations, or any configuration where the fibers intentionally overlap or are wound about at least a portion of the length of the fibers. Likewise, non-metallic materials other than those described herein may be utilized for the twisted fibers.

As indicated above with respect to FIG. 2, the brush seal 10 can be attached to a rotating shaft 24 (e.g., base) at a first end for an intershaft seal configuration and can contact a rotor 26 at a second end. Such description is by way of example only. In one arrangement, the brush seal 10 is attached to a stationary housing and contacts a rotor operable to rotate about an axis of rotation.

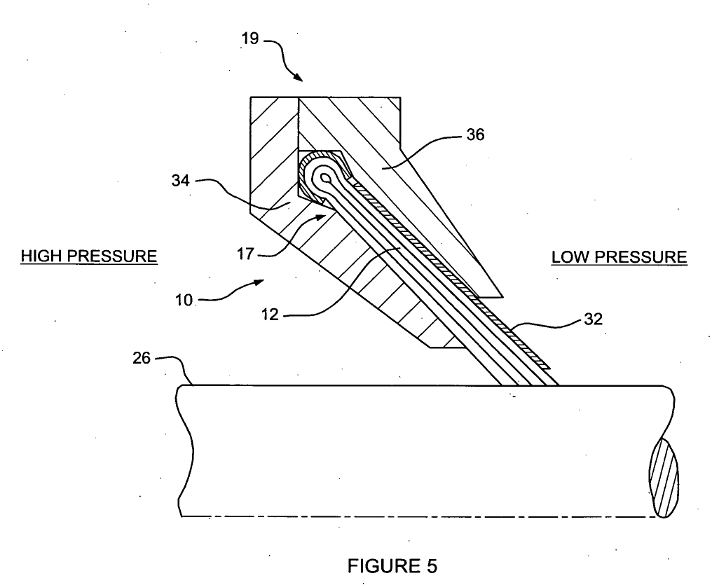

As indicated above with respect to FIG. 2, the brush member pack 17 is held in an axially inclined position toward the low pressure side by a support member 19 having a pair of thinner front and back plates 30, 32 and a pair of more rigid front and back plates 34, 36. Such description and illustration is by way of example only. In one embodiment, the support member 19 includes a single flexible plate attached thereto. For example, as shown in FIG. 5, brush member pack 17 is held in an axially inclined position toward the low pressure side by a support member 19 having rigid front and back plates 34, 36 and a single flexible back plate 32, such as formed from a metallic sheet stock, disposed in proximity to the low pressure side. The back plate 32 is designed to protect the brush seal members 12 from damage during installation and support the brush member pack 17 while under pressure, for example. Additionally, in one embodiment, the brush member pack 17 can be held in an axially inclined position toward the low pressure side by a support member 19 having rigid front and back plates 34, 36 and a single flexible front plate 30, such as formed from a metallic sheet stock, disposed in proximity to the high pressure side. In one arrangement, the flexible front plate 30 provides a restoring force to the brush seal members 12 to return the brush seal members 12 to a given position after a deformation of the brush seal members 12.

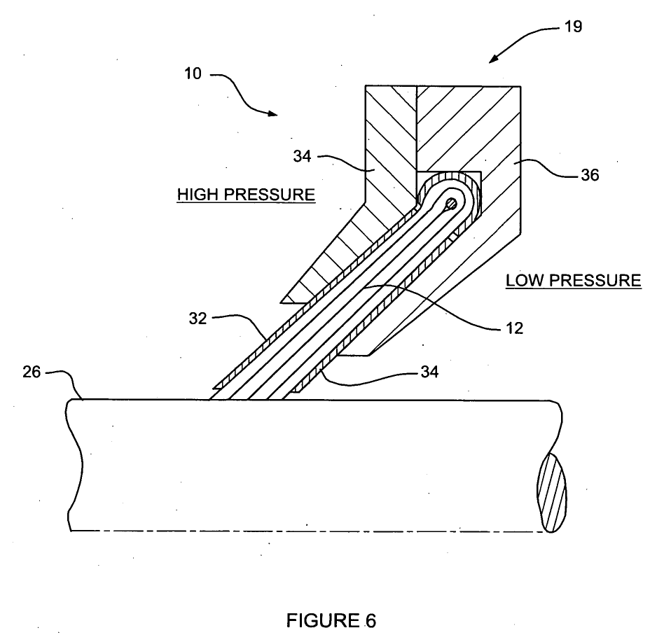

As indicated above with respect to FIG. 2, the brush seal pack 17 can be attached to a rotating shaft 24 (e.g., base) at a first end for an intershaft seal configuration and contact a rotor 26 at a second end. In order to facilitate bending of the brush seal members 12 during rotor excursions, the brush seal pack 17 is inclined axially (i.e., coned) in the direction of the fluid flow, i.e., toward the low pressure (L_{P}) side. In such an arrangement, the net radial deflection of the flexible plates 30, 32 resulting from centrifugal force and pressure, causes the brush seal 10 to act as a controlled gap seal for relatively high surface speeds. In another embodiment, as shown in FIG. 6, the support member 19 (i.e., the rigid front and back plates 34, 36 and the flexible front and back plates 30, 32) inclines (i.e., cones) the brush seal pack 17 axially toward a high pressure (Hₚ) side. In such an arrangement, as the brush seal system is pressurized, the flexible front and back plates 30, 32 bend to close a sealing gap or increase a seal contact pressure with the rotor 26 to reduce leakage. In such an arrangement, the brush seal 10 can act as a contacting seal for low leakage at relatively lower surface speeds.

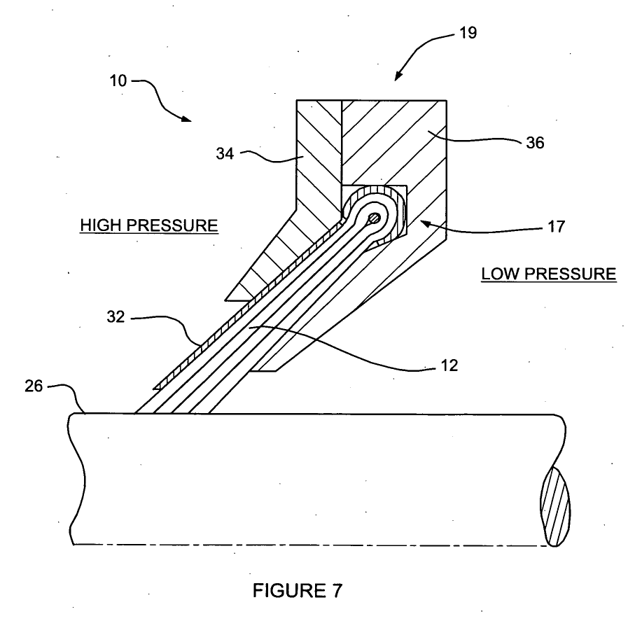

FIG. 6 illustrates the brush seal pack 17 as being inclined axially (i.e., coned) by the rigid front and back plates 34, 36 and by the flexible front and back plates 30, 32, toward a high pressure (Hₚ) side. Such an illustration is by way of example only. In one arrangement, the support member 19 includes rigid front and back plates 34, 36 and a single flexible plate attached thereto. For example, as shown in FIG. 7, the brush seal pack 17 is held in an axially inclined position by rigid front and back plates 34, 36 as well as by a flexible front plate 30, such as formed from a metallic sheet stock. The front plate 30 is designed to contact the brush seal pack 17 when the system builds up pressure. In such an arrangement, the front plate 16a can act as a flow deflector minimizing brush seal member blow-down on the rotating surface causing excessive brush seal member wear. Additionally, the front plate 30 can provide a restoring force to return the brush seal pack 17 into a sealing configuration after rotor excursion. Also, in one embodiment, the brush member pack 17 can be held in an axially inclined position toward the high pressure side by a support member 19 having rigid front and back plates 34, 36 and a single flexible back plate 32, such as formed from a metallic sheet stock, disposed in proximity to the low pressure side. As indicated above, the brush seal members 12 can be formed from a metallic material which are mechanically captured by the support member 19 and supported during use. Such mechanical capturing of the metallic brush seal minimizes or can eliminate the need to weld metallic bristles to fabricate brush seals. While a variety of metallic materials can be used to form the bristles, in one example, the bristles can be formed from a nickel and cobalt based superalloy. In such an arrangement, the metallic bristles can be used in applications requiring surface speeds of less than about 1200 ft/sec and temperatures below about 1500° F. and usually below about 1200-1300° F.

What is claimed:

1. A brush seal comprising:
a plurality of metallic bristles having a bristle length; and
a support member constructed and arranged to support the plurality of metallic bristles, the support member having at least one flexible plate extending at least substantially along the bristle length of the plurality of bristles.

2. The brush seal of claim 1, wherein the at least one flexible plate defines a set of slots extending from an inner diameter side toward an outer diameter side of the least one flexible plate to divide the least one flexible plate into multiple flexible plate segments.

3. The brush seal of claim 1, wherein the support includes (i) a thicker outer diameter portion constructed and arranged to support the plurality of metallic bristles against pressure in an operating environment, and the at least one flexible plate includes (ii) a thinner inner diameter portion constructed and arranged to apply a holding force on the plurality of metallic bristles to maintain contact between the plurality of metallic bristles and an external object of the operating environment during operation.

4. The brush seal of claim 1, wherein the plurality of metallic bristles form a bristle pack and wherein the at least one flexible plate comprises a front plate and a back plate, the front plate and the back plate being constructed and arranged to elastically return the bristle pack from a displaced position to an original position in a spring back manner following displacement of the bristle pack.

5. The brush seal of claim 4, wherein:
the front plate defines a set of slots extending from an inner diameter side toward an outer diameter side of the front plate to divide the front plate into multiple flexible front plate segments; and
the back plate defines a set of slots extending from an inner diameter side toward an outer diameter side of the back plate to divide the back plate into multiple flexible back plate segments.

6. The brush seal of claim 1, wherein the at least one flexible plate is formed of a metallic material.

7. The brush seal of claim 1, wherein the plurality of metallic bristles is configured as a bristle pack and wherein the support member is constructed and arranged to mount to a base and to orient the bristle pack in an axially inclined position relative to the base.

8. The brush seal of claim 7, wherein the support member is constructed and arranged to position the plurality of metallic bristles of the bristle pack to extend toward a high pressure side when orienting the bristle pack in the axially inclined position relative to the base.

9. The brush seal of claim 7, wherein the support member is constructed and arranged to position the plurality of metallic bristles of the bristle pack to extend toward a low pressure side when orienting the bristle pack in the axially inclined position relative to the base.

10. A brush seal system, comprising:
a rotor;
a rotatable shaft, the rotor and the rotatable shaft defining a space therebetween; and
a brush seal disposed between the rotor and the rotatable shaft to divide the pathway into a high pressure side and a low pressure side, the brush seal including:
a plurality of metallic bristles having a bristle length; and
a support member constructed and arranged to support the plurality of metallic bristles, the support member having at least one flexible plate extending at least substantially along the bristle length of the plurality of bristles.

11. The brush seal system of claim 10, wherein the at least one flexible plate defines a set of slots extending from an inner diameter side toward an outer diameter side of the least one flexible plate to divide the least one flexible plate into multiple flexible plate segments.

12. The brush seal system of claim 11, wherein the support member includes (i) a thicker outer diameter portion constructed and arranged to support the plurality of metallic bristles against pressure in an operating environment, and at least one flexible plate includes (ii) a thinner inner diameter portion constructed and arranged to apply a holding force on the plurality of metallic bristles to maintain contact between the plurality of metallic bristles and an external object of the operating environment during operation.

13. The brush seal system of claim 10, wherein the plurality of metallic bristles form a bristle pack and wherein the at least one flexible plate comprises a front plate and a back plate, the front plate and the back plate being constructed and arranged to elastically return the bristle pack from a displaced position to an original position in a spring back manner following displacement of the bristle pack.

14. The brush seal system of claim 13, wherein:
the front plate defines a set of slots extending from an inner diameter side toward an outer diameter side of the front plate to divide the front plate into multiple flexible front plate segments; and
the back plate defines a set of slots extending from an inner diameter side toward an outer diameter side of the back plate to divide the back plate into multiple flexible back plate segments.

15. The brush seal system of claim 10, wherein the at least one flexible plate is formed of a metallic material.

16. The brush seal system of claim 10, wherein the plurality of metallic bristles is configured as a bristle pack and wherein the support member is constructed and arranged to mount to the rotatable shaft and orient the bristle pack in an axially inclined position relative to an axis of rotation defined by the rotatable shaft.

17. The brush seal system of claim 16, wherein the support member is constructed and arranged to position the plurality of metallic bristles of the bristle pack to extend toward a high pressure side when orienting the bristle pack in the axially inclined position relative to the axis of rotation defined by the rotatable shaft.

18. The brush seal system of claim 16, wherein the support member is constructed and arranged to position the plurality of metallic bristles of the bristle pack to extend toward a low pressure side when orienting the bristle pack in the axially inclined position relative to the axis of rotation defined by the rotatable shaft.

19. A brush seal, comprising:
a plurality of brush seal members having a brush seal member length; and
a support member constructed and arranged to support the plurality of brush seal members, the support member having at least one flexible plate extending at least substantially along the brush seal member length of the plurality of brush seal members s;
wherein the plurality of brush seal members are configured as a brush seal pack and wherein the support member is constructed and arranged to mount to a base and to orient the brush seal pack in an axially inclined position relative to the base.

20. The brush seal of claim 19, wherein the support member is constructed and arranged to position the plurality of brush seal members of the brush seal pack to extend toward a high pressure side when orienting the brush seal pack in the axially inclined position relative to the base.

21. The brush seal of claim 19, wherein the support member is constructed and arranged to position the plurality of brush seal members of the brush seal pack to extend toward a low pressure side when orienting the brush seal pack in the axially inclined position relative to the base.

22. The brush seal of claim 19, wherein the plurality of brush seal members comprises metallic bristles.

23. The brush seal of claim 19, wherein the plurality of brush seal members comprises non-metallic fibers.
